(19) United States
(12) Patent Application Publication
(10) Pub. No.: US 2010/0261512 A1
(43) Pub. Date: Oct. 14, 2010

(54) Checkbook for disabled users

(76) Inventor: Karmichael Spiller, Jackson, MS (US)

Correspondence Address: LITMAN LAW OFFICES, LTD., POST OFFICE BOX 15035, CRYSTAL CITY STATION, ARLINGTON, VA, 22215, US

(21) Appl. No.: 12/385,547

(22) Filed: Apr. 10, 2009

(51) Int. Cl. B41L 1/24; B42D 15/00

(52) U.S. Cl. 462/53; 283/58

(57) ABSTRACT

The checkbook for disabled users is a book of checks including instructional information for check writing for mentally disabled users, and further providing easily removable and manipulable checks for physically disabled users. The checkbook includes a plurality of checks removably bound to one another, with each check being removably attached to a spine through perforations. Opposed cutout portions may be formed between upper corners of each check and the spine, providing pre-cut scores for each check. Each successive check from a topmost one of the plurality of checks to a bottommost one of the plurality of checks has a decreasing length and a decreasing width. Further, the checkbook includes opposed top and bottom covers secured to the spine. On a lower surface of the top cover, a set of indicia is imprinted, providing the user with instructional information, such as the spelling of numbers and instructions on general check writing.

### BACKGROUND OF THE INVENTION

1. Field of the Invention

The present invention relates to checkbooks and the like, and particularly to an improved checkbook for disabled users that includes instructional information for check writing for mentally disabled users, and further provides easily removable and manipulable checks for physically disabled users.

2. Description of the Related Art

The Americans with Disabilities Act of 1990 (ADA) is the short title of United States (Pub.L. 101-336, 104 Stat. 327, enacted Jul. 26, 1990), codified at 42 U.S.C. §12101 et seq. It was signed into law on Jul. 26, 1990, by President George H. W. Bush, and later amended with changes effective Jan. 1, 2009. The ADA is a wide-ranging civil rights law that prohibits, under certain circumstances, discrimination based on disability. It affords similar protections against discrimination to Americans with disabilities as the Civil Rights Act of 1964, which made discrimination based on race, religion, sex, national origin, and other characteristics illegal. Disability is defined as “a physical or mental impairment that substantially limits a major life activity.” Current studies estimate that approximately 43,000,000 people in the U.S. suffer from one or more mental or physical disability.

Transferable instruments, such as checks, are common forms of payment around the world. Users with mental disabilities, such as dyslexia, for example, memory-based diseases, such as Alzheimer's disease, age-related dementia, or physical ailments, such as rheumatoid arthritis or Parkinson's disease, or users who suffer from physical disabilities may have difficulty in handling and writing checks. Check writing requires the user to know how to properly spell the numbers involved in payment amounts, which may be difficult for a dyslexic person or user, for example, and also to write particular information in each field (the payment amount in numerals in one field, the payment amount in words in another field, the user's signature in another field, etc.), which may be difficult to remember for a user with dementia or with a mental disability.

Dyslexia is a learning disability that manifests itself primarily as a difficulty with written language, particularly with reading. It is separate and distinct from reading difficulties resulting from other causes, such as a non-neurological deficiency with vision or hearing, or from poor or inadequate reading instruction. Evidence suggests that dyslexia results from differences in how brain processes written and spoken language. Although dyslexia is thought to be the result of a neurological difference, it is not an intellectual disability. Dyslexia is diagnosed in people of all levels of intelligence. A user with dyslexia may have particular difficulty in the writing and handling of checks, particularly in spelling particular numerals in the currency amount of the check.

Alzheimer's disease (AD), also called Alzheimer disease, Senile Dementia of the Alzheimer Type (SDAT) or simply Alzheimer's, is the most common form of dementia. This incurable, degenerative, and terminal disease was first described by German psychiatrist Alois Alzheimer in 1906 and was named after him. Generally it is diagnosed in people over 65 years of age, although the less-prevalent early-onset Alzheimer's can occur much earlier. An estimated 26.6 million people worldwide had Alzheimer's in 2006; this number may quadruple by 2050. Although each sufferer experiences Alzheimer's in a unique way, there are many common symptoms. The earliest observable symptoms are often mistakenly thought to be “age-related” concerns, or manifestations of stress. In the early stages, the most commonly recognized symptom is memory loss, such as difficulty in remembering recently learned facts. When a doctor or physician has been notified, and AD is suspected, the diagnosis is usually confirmed with behavioral assessments and cognitive tests, often followed by a brain scan if available. As the disease advances, symptoms include confusion, irritability and aggression, mood swings, language breakdown, long-term memory loss, and the general withdrawal of the sufferer as their senses decline. Gradually, bodily functions are lost, ultimately leading to death. Individual prognosis is difficult to assess, as the duration of the disease varies. AD develops for an indeterminate period of time before becoming fully apparent, and it can progress undiagnosed for years. The mean life expectancy following diagnosis is approximately seven years. Fewer than three percent of individuals live more than fourteen years after diagnosis. As described above with regard to dyslexic users, those suffering from AD may also have difficulty in writing checks, particularly in the spelling of numerals. Further, the confusion caused by AD may also result in the user becoming confused regarding the overall process of a check-based transaction, and basic instruction may be needed.

Further, the handling of checks, such as inserting the check into an envelope or wallet, or tearing the check from the checkbook, may be straining to someone with a physical disability or infirmity. Sufferers of Parkinson's disease or rheumatoid arthritis may find the handling of checks and checkbooks particularly difficult. Thus, a checkbook for disabled users solving the aforementioned problems is desired.

### SUMMARY OF THE INVENTION

The checkbook for disabled users is a book of checks including instructional information for check writing for mentally disabled users, and further providing easily removable and manipulable checks for physically disabled users. The checkbook includes information on both the writing of checks and the spelling of numerals, as well as being particularly contoured for ease of handling. The checkbook includes a plurality of checks removably bound to one another along respective upper edges thereof. Preferably, each check is removably attached to a spine through perforations or the like. Opposed cutout portions may be formed between upper corners of each check and the spine, providing pre-cut scores for each check, allowing each check to be torn from the spine easily.

Each check further includes a lower edge and a pair of opposed side edges, with each successive check from a topmost one of the plurality of checks to a bottommost one of the plurality of checks having a decreasing length and a decreasing width. Preferably, a plurality of carbon sheets or the like are also provided, interleaved with the checks, for recordation of transactions. The carbon sheets are arranged to include the same overall contouring described above with regard to the checks. Thus, the side edges and lower edge of the checkbook are tapered, with each successive check and corresponding carbon sheet decreasing slightly in both width and length. This allows for the grasping of the topmost check to be removed easier than in a conventional checkbook, particularly when the checks are removed along the lower corners of the checkbook, along with ease in selection of a check. Preferably, the lower corners of each check are rounded, allowing for comfortable grasping of the corner, and for ease of insertion of each check into an envelope or the like.

An upper surface of each check has a first set of indicia imprinted thereon, representing conventional or typical check indicia, such as a “Pay to” indication and line, a signature line and the like. Further, the checkbook preferably includes opposed top and bottom covers secured to the spine along upper edges thereof. On a lower surface of the top cover, a second set of indicia is preferably imprinted. The second set of indicia provides the user with instructional information, such as the spelling of numbers and instructions on general check writing. A third set of indicia may further be imprinted on each check, representing the disabled status of the user, thus indicating to a merchant or the like that special care should be given to the user.

As an alternative to the second set of indicia formed on the lower surface of the upper cover, a personal digital assistant or the like may be provided along with the checkbook as a kit. The personal digital assistant will include the instructional information to be displayed on a display thereof. Further, the checkbook may have carbon paper sheets interleaved between the plurality of checks, to keep a record of each check written, or the check writing information may be recorded on the personal digital assistant at the time the check is written.

These and other features of the present invention will become readily apparent upon further review of the following specification and drawings.

### BRIEF DESCRIPTION OF THE DRAWINGS

FIG. 1 is a perspective view of a checkbook for disabled users according to the present invention.

FIGS. 2A and 2B are partial perspective views of the checkbook for disabled users according to the present invention.

FIG. 3 is a perspective view of the checkbook for disabled users of FIG. 1, shown without a cover.

FIG. 4 is an environmental perspective view of a single check of the checkbook for disabled users according to the present invention, shown being inserted into an envelope.

FIG. 5 is a perspective view of a checkbook kit for disabled users according to the present invention.

Similar reference characters denote corresponding features consistently throughout the attached drawings.

### DETAILED DESCRIPTION OF THE PREFERRED EMBODIMENTS

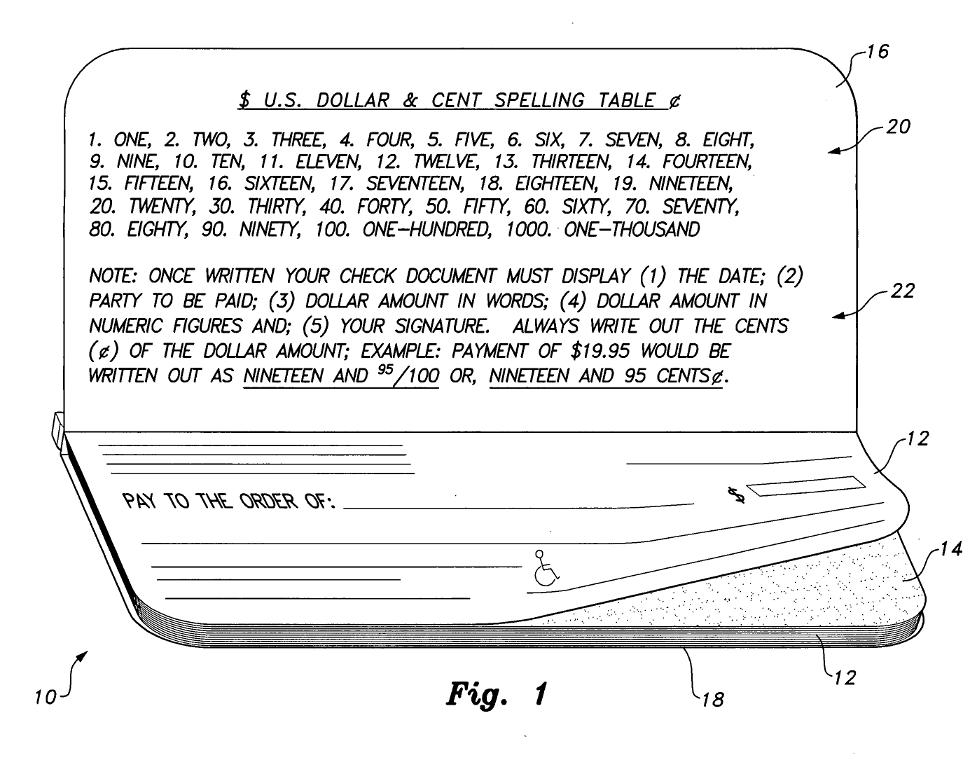

Now referring to FIG. 1, there is shown a checkbook for disabled users 10. The checkbook for disabled users 10 is a book of checks 12 including instructional information for check writing for mentally disabled users, and further providing easily removable and manipulable checks for physically disabled users, as will be described in detail below. It should be understood that the size, shape and decorative appearance of the checkbook 10 and of checks 12 are shown for exemplary purposes only.

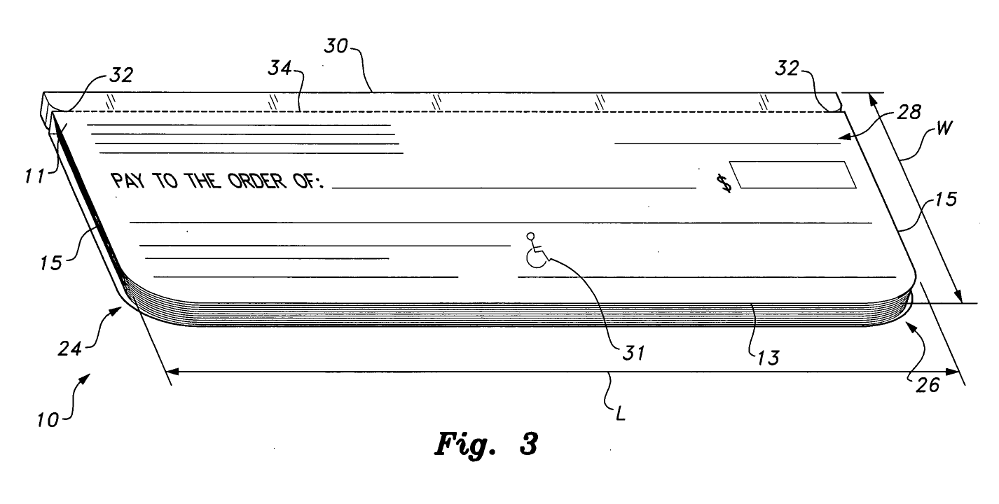

The checkbook 10 includes a plurality of checks 12 detachably secured to one another along respective upper edges 11 thereof. FIG. 3 shows the checkbook 10 without top cover 16 in order to better illustrate the attachment of checks 12 along edges 11 to spine 30. Preferably, each check 12 is removably attached to spine 30 through perforations 34 or the like, as is conventionally known. Opposed cutout portions 32 may be formed between upper corners of each check and the spine 30, providing pre-cut scores for each check 12, allowing each check 12 to be torn from the spine 30 in a manner which is easier than in a conventional checkbook. As shown perforations 34 extend between the opposed cutout portions 32 in a linear manner. Thus, physically disabled users may easily remove each check 12 from the checkbook 10, without excessive force or manipulation being required. It should be understood that cutout portions 32 are shown for exemplary purposes only, and may be formed as grooves, cuts, scores, indentation lines or any other suitable easy release for the upper corners of checks 12. Carbon sheets 14 are similarly attached and contoured.

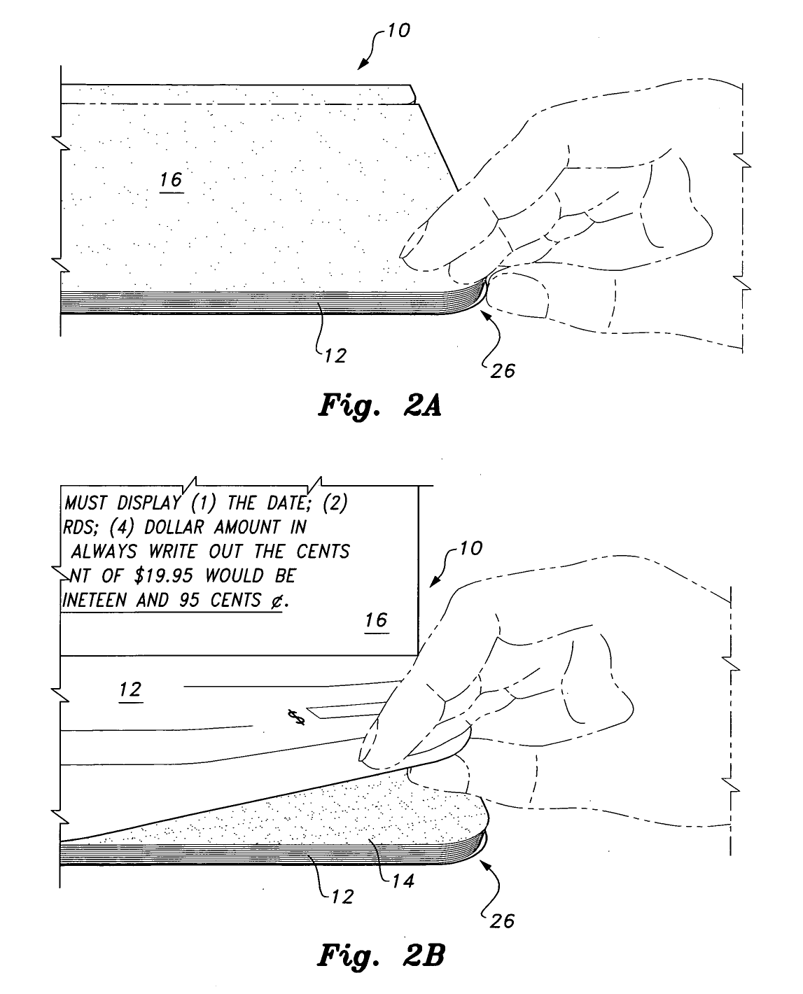

Each check 12 (and corresponding carbon sheet 14) further includes a lower edge 13 and a pair of opposed side edges 15, with each successive check 12 from a topmost one of the plurality of checks 12 to a bottommost one of the plurality of checks 12 having a decreasing length L and a decreasing width W. As best illustrated in FIGS. 2A and 2B, the side edges 15 and lower edge 13 of the checkbook 10 are tapered, with each successive check 12 decreasing slightly in both width and length. This allows grasping of the topmost check 12 to be removed from the checkbook 10 easier than in a conventional checkbook, particularly when the user grasps one of the lower corners 24, 26 to tear the check 12 along the perforations, as illustrated. As noted, preferably, a plurality of carbon sheets 14 or the like are provided, interleaved with the checks 12, for recordation of transactions. The carbon sheets 14 are arranged to include the same overall contouring described above with regard to the checks 12. The shape and attachment of checks 12, described above, is similarly applied to the carbon sheets 14.

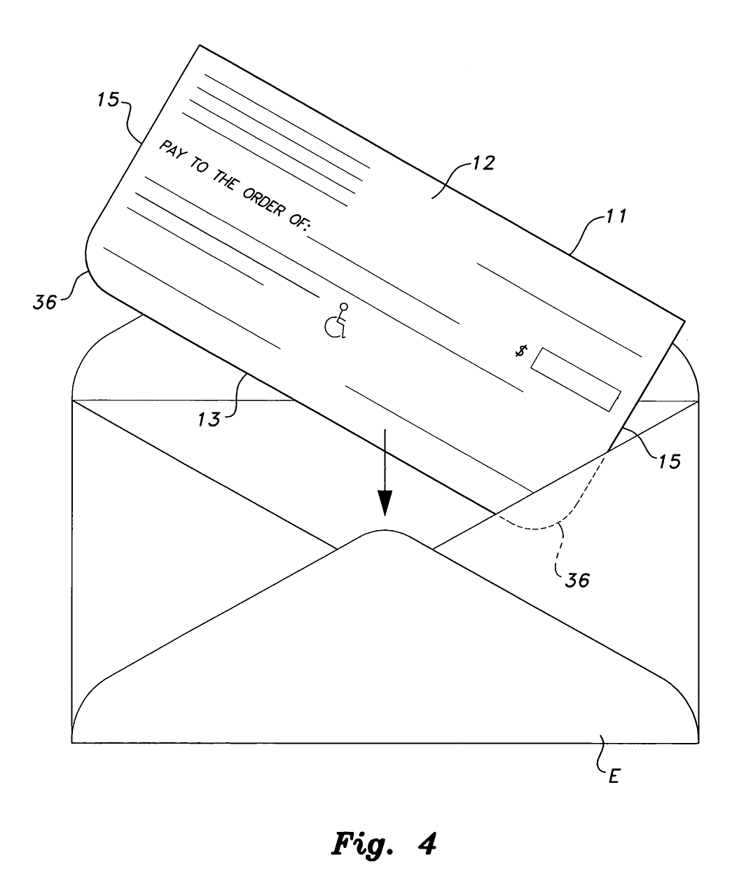

Further, as best shown in FIG. 4, the lower corners 36 of each check 12 are rounded. After a check 12 has been removed from checkbook 10, the rounded lower corners 36 allow for ease of insertion of the check 12 into an envelope E, a wallet, a checkbook holder or the like, requiring less control or coordination than a conventional rectangular edge. The tapering and rounding of the lower corners is of particular use to users with physical disabilities or ailments, such as, for example, rheumatoid arthritis or Parkinson's disease. It should be understood that, as an alternative, the width and lengths of the checks may also be equal, as in a conventional checkbook. Further, it should be understood that the lower corners may alternatively be rectangular.

An upper surface of each check 12 has a first set of indicia 28 imprinted thereon, representing conventional or typical check indicia, such as a “Pay to” indication and line, a signature line and the like. It should be understood that first indicia 28 is shown for exemplary purposes only, and may be formed as any suitable wording or symbols found on a conventional transferable instrument, such as a check. Further, the checkbook preferably includes opposed top and bottom covers 16, 18, respectively, secured to the spine 30 along upper edges thereof. On a lower surface of the top cover 16, a second set of indicia 20 is preferably imprinted. The second set of indicia 20 provides the user with instructional information, such as the spelling of numbers. Such spelling is of particular utility to users with mental disabilities, such as dyslexia, for example. As shown in FIG. 1, the numerals 1-20 are provided, along with the spelling of each numeral next to corresponding numeral. Beyond numerals 1 through 20, numerals 30, 40, 50, 60, 70, 80, 90, 100, and 1,000 are also provided, along with their corresponding spellings. By providing these 29 numerals, almost any amount that a user is likely require in the writing of a check amount is spelled out for the user in an easy-to-read and easy-to-understand manner. As an example, if a user is to write a check for $19.95, the user may consult indicia 20 to find the spelling of nineteen corresponding to the numeral “19”, then the spelling of ninety corresponding to “90” and the spelling of five, corresponding to the numeral “5”. In the example shown in FIG. 1, it should be understood that the listing of numerals and their spellings may be re-arranged in a customized manner, for example for users who transpose spellings or numbers due to their disabilities.

Additional indicia 22 may further be imprinted on the lower surface of top cover 16, representing instructions on general check writing. Such information is particularly useful for users with memory-based disabilities, such as Alzheimer's disease. It should be understood that the United States dollar and cent information, along with the usage of Arabic numerals and English spellings, are shown for exemplary purposes only. Any suitable type of information, which may be region or language dependent, may be utilized. The selected font is chosen so as to be easy to read, such as 12 point Comic Sans MS, for example. It should be understood that the fonts and overall configuration of the indicia illustrated in the Figures is shown here for illustrative and exemplary purposes only. As shown, each numeral is provided, along with its corresponding spelling, allowing the user to easily reference the numeral of interest and then read the corresponding spelling.

A third set of indicia 31 may further be imprinted on each check 12, representing the disabled status of the user, thus indicating to a merchant or the like that special care should be given to the user. It should be understood that the “handicapped” symbol shown in the Figures for indicia 31 is shown for exemplary purposes only. Such a symbol could also alternatively be provided in the watermark of the check, or in any other suitable or desired configuration.

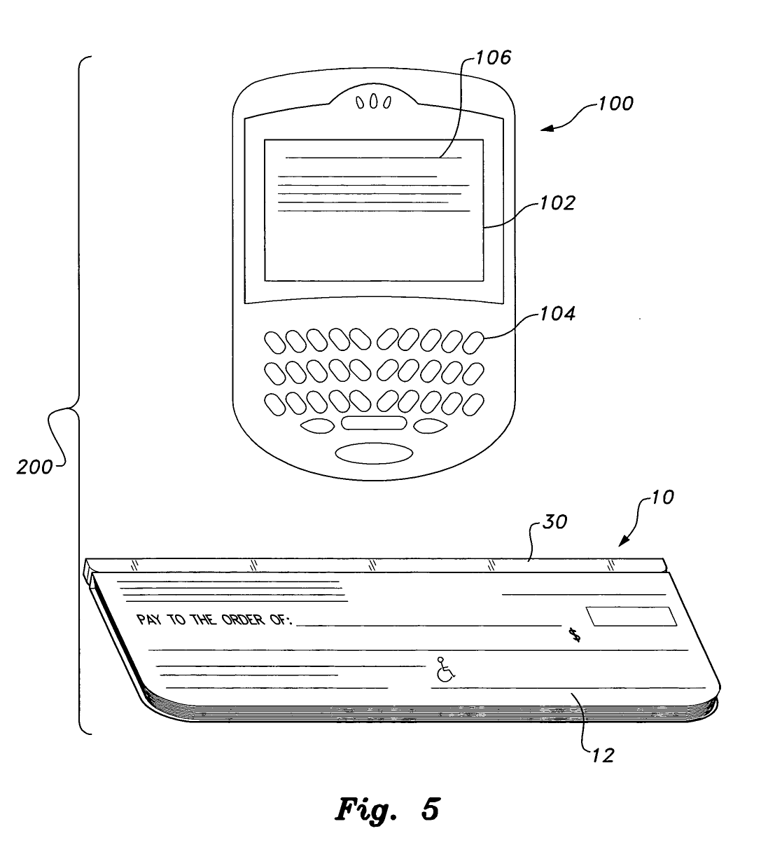

As an alternative to the usage of the second sets of indicia 20, 22 formed on the lower surface of top cover 16, a personal digital assistant 100 or the like may be provided along with the checkbook 10 as a kit 200, as shown in FIG. 5. The personal digital assistant 100 is used to display the same information displayed by indicia 20, 22. It should be understood that the personal digital assistant 100 is shown for exemplary purposes only, and that any suitable portable electronic device, such as a cellular telephone, a calculator or the like, may also be used. The personal digital assistant 100 includes a display 102 and an input keypad 104, as is conventionally known. The instructional information 106, replacing indicia 20, 22, is displayed on display 102, rather than on top cover 16, or under a carbon sheet 14. As noted above, the checkbook 10 may have carbon paper sheets 14 interleaved between the plurality of checks 12, to keep a record of each transaction, or in the embodiment of FIG. 5, the transaction information may be recorded on the personal digital assistant 100 at the time the check is written. Indicia such as that printed on the lower surface of the top cover is preferably printed on the lower surface of each carbon paper sheet 14.

As a further alternative, the spelling and general information of indicia 20, 22 could be provided by the bank itself (or any other suitable location, such as a merchant), printed on postcards, posters, signs, placards or the like. Such a sign, for example, would include the information of indicia 20, 22 and be posted over (in the example of a bank) the check writing table or surface.

It is to be understood that the present invention is not limited to the embodiments described above, but encompasses any and all embodiments within the scope of the following claims.

I claim:

1. A checkbook for disabled users, comprising a plurality of checks removably bound to one another along respective upper edges thereof, each of the checks having a lower edge and a pair of opposed side edges, each successive check from a topmost one of the checks to a bottommost one of the checks having a decreasing length, an upper surface of each of the checks having a first set of indicia imprinted thereon.

2. The checkbook for disabled users as recited in claim 1, wherein each successive check from the topmost one of said plurality of checks to the bottommost one of said plurality of checks further has a decreasing width.

3. The checkbook for disabled users as recited in claim 2, further comprising opposed top and bottom covers secured along upper edges thereof to the upper edges of said plurality of checks.

4. The checkbook for disabled users as recited in claim 3, wherein a lower surface of the top cover has a second set of indicia imprinted thereon, the second set of indicia representing instructional information for the user.

5. The checkbook for disabled users as recited in claim 3, further comprising a plurality of carbon paper sheets alternately interleaved between said checks, each of the carbon paper sheets having dimensions matching those of an adjacent one of said plurality checks.

6. The checkbook for disabled users as recited in claim 3, wherein the upper surface of each said check further has a third set of indicia imprinted thereon, the third set of indicia representing the user's disabled status.

7. The checkbook for disabled users as recited in claim 3, further comprising a spine, each said check being releasably secured to the spine along the upper edge thereof.

8. The checkbook for disabled users as recited in claim 7, wherein each said check is releasably attached to the spine by perforated attachment thereto.

9. The checkbook for disabled users as recited in claim 9, wherein opposed cutout portions are formed between upper corners of each said check and the spine.

10. The checkbook for disabled users as recited in claim 3, wherein opposed lower corners of each said check are rounded.

11. A checkbook for disabled users, comprising:
a plurality of checks removably bound to one another along respective upper edges thereof, each of the checks having a lower edge and a pair of opposed side edges, each successive check from a topmost one of the checks to a bottommost one of the checks having a decreasing length, an upper surface of each of the checks having a first set of indicia imprinted thereon; and
opposed top and bottom covers secured along upper edges thereof to the upper edges of the checks.

12. The checkbook for disabled users as recited in claim 11, wherein each successive check from the topmost one of said plurality of checks to the bottommost one of said plurality of checks has a decreasing width.

13. The checkbook for disabled users as recited in claim 12, wherein a lower surface of the top cover has a second set of indicia imprinted thereon, the second set of indicia representing instructional information for the user.

14. The checkbook for disabled users as recited in claim 13, further comprising a plurality of carbon paper sheets alternately interleaved between said checks, each of the carbon paper sheets having dimensions matching those of an adjacent one of said plurality checks.

15. The checkbook for disabled users as recited in claim 13, wherein the upper surface of each said check further has a third set of indicia imprinted thereon, the third set of indicia representing the user's disabled status.

16. The checkbook for disabled users as recited in claim 13, further comprising a spine, each said check being releasably secured to the spine along the upper edge thereof.

17. The checkbook for disabled users as recited in claim 16, wherein each said check is releasably attached to the spine by perforated attachment thereto.

18. The checkbook for disabled users as recited in claim 17, wherein opposed cutout portions are formed between upper corners of each said check and the spine.

19. The checkbook for disabled users as recited in claim 13, wherein opposed lower corners of each said check are rounded.

20. A checkbook kit for disabled users, comprising:
a plurality of checks removably bound to one another along respective upper edges thereof, each of the checks having a lower edge and a pair of opposed side edges, each successive check from a topmost one of the checks to a bottommost one of the checks having a decreasing length and a decreasing width, an upper surface of each of the checks having a first set of indicia imprinted thereon;
opposed top and bottom covers secured along upper edges thereof to the upper edges of the checks; and
a personal digital assistant for displaying instructional information to the user.
